(19) United States
(12) Patent Application Publication
(10) Pub. No.: US 2008/0195347 A1
(43) Pub. Date: Aug. 14, 2008

(54) System and Method for Detecting Concealed Objects

(75) Inventor: Refael Gatt, Rakefet (IL)

Correspondence Address: BROWDY AND NEIMARK, P.L.L.C.;624 NINTH STREET, NW, SUITE 300, WASHINGTON, DC, 20001-5303, US

(73) Assignee: GLOBAL SECURITY DEVICES LTD., Misgav (IL)

(21) Appl. No.: 11/816,972

(22) PCT Filed: Feb. 23, 2005
(86) PCT No.: PCT/IL2005/000223

§ 371 Date: Aug. 23, 2007

(51) Int. Cl. G01K 13/00; G01J 5/02

(52) U.S. Cl. 702/131; 702/134

(57) ABSTRACT

A method and system for detecting a concealed foreign object carried by a body (P) by collecting radiation (R) from the body (P) indicative of a radiation response of the body (P) to environmental temperature changes which the body (P) is subjected to while entering or emerging from a transient inducing space (TIS) of environmental temperature changes and generating thermal data indicative of the response. The TIS has a volume substantially large relative to that of the body (P) and is configured to enable concentration of a temperature field within the TIS. The TIS may be defined by a gate (21) having at least one of the following configurations: side walls (21A, 21B) at opposite sides of the body path or side walls (21A, 21B) at opposite sides of the body path and an upper wall (21C) above the body path. The gate may be a substantially -shaped gate, -shaped gate, or a carousel gate.

### FIELD OF THE INVENTION

This invention is generally in the field of monitoring/inspecting techniques, and relates to a method and system for detecting objects carried by a body.

### BACKGROUND OF THE INVENTION

The known methods for detecting concealed explosives include metal detection, X-ray scanning, gas chromatography and mass spectroscopy. These methods require close proximity to the bearer of the explosives. Another technique based on laser spectroscopy, is allegedly capable of detecting suspicious vapors at a distance of several meters.

Yet another technique, utilizing the so-called “electronic nose”, is based on the use of coated piezoelectric crystals. A high sensitivity and simple relationship between mass and frequency make the crystal microbalance as an ideal tool for the study of adsorption, and as a selective chemical sensor.

A common feature of most of the known techniques is that they are oriented towards detecting specific properties of the suspected explosives.

### SUMMARY OF THE INVENTION

There is a need in the art to facilitate detection of concealed objects carried by a body, by providing a novel detection method and system capable of detecting such objects with high accuracy and very quickly (in a few seconds). When concerning people screening, it is also needed to detect the concealed objects without compromising the passenger's health and with minimal invasion to his privacy.

Here, the term “body” signifies an exothermic body having substantially uniform exothermic properties, such as a human or animal body, or a substantially uniform surface of any structure, for example an envelope either containing or not another paper sample, or a surface of a bag (or trunk or suitcase).

The main idea of the present invention is based on the understanding of the thermal regulation of a human or animal body (or exothermic body generally): in the presence of environmental temperature changes (e.g., of tens of degrees), the temperature of the human body remains constant to within a fraction of a degree. The body is thus an ideal background for the thermal detection of a concealed foreign object (i.e., relatively thermally passive object).

Hence, when subjecting a body to an external temperature field, the body undergoes temperature changes with a different speed as compared to a foreign object carried by the body.

The invention utilizes the principles of a technique disclosed in the co-pending patent application No. PCT/IL 2004/000763, by the same inventor as the present application. According to this technique, in order to observe bulk properties such as the detection of concealed objects, the transient thermal response should be followed. An object concealed in a body is detected by transiently heating or cooling at least part of the body surface, imaging that part of the surface in the mid- or far-infrared, and seeking the concealed object in the image(s); or alternatively, the body is imaged as the temperature of its environment fluctuates naturally. Preferably, multiple infrared images are acquired and are processed to provide a measure of the body's thermal diffusivity, the object then being sought according to that measure of thermal diffusivity. Most preferably, the heated/cooled part of the surface is imaged in the visible or near-infrared band too, and the two sets of images are processed together to provide the measure of the body's thermal diffusivity.

The inventor has found that when a body is subjected to environmental temperature changes applied substantially simultaneously and substantially to the entire body, the environmental temperature change is enough to induce a transient response of the body even if the temperature difference is of several degrees (about 10 degrees or less). To this end, a body should be transferred from a region having a first temperature T₁ into a space, termed here “Transient Inducing Space” or “TIS”, having a second temperature T₂ (higher or lower than T₁), or should be sequentially subjected to different temperature fields while located in such a TIS. The TIS is configured such that its volume is large enough compared to that of the body such that the entering of the body into the TIS has a negligible effect on the TIS temperature; and is configured to enable concentration of a temperature field within the TIS with a substantially uniform angular distribution of the temperature field in the TIS.

It is important to note that the invention utilizes substantially simultaneous heating/cooling of the entire space where the body is located (rather than local heating) where the space is configured to ensure the temperature field concentration therein, to thereby enable quick and effective detection of the existence of any foreign object carried by the body.

The invention utilizes a temperature source, which may be associated with the TIS, or with the outside region at the input and/or output of the TIS. The TIS configuration provides for affecting the body by the environmental temperature changes (when entering or emerging from the TIS, or while being in the TIS) in a substantially uniform and immediate way.

Practically, TIS is a space defined by a gate arrangement, for example surrounding the body path. The gate arrangement, which may be formed by a building construction or may be a separate structure, defines at least side walls at opposite sides of the body path, or preferably also an upper wall above the body path. Such a gate may have a Π- or ∩-like shape, or may be a carousel-like gate. It should be noted that the gate may define any geometry of an inside space, such as rectangular, or substantially circular. In other words, the side walls may and may not be substantially parallel to each, or may form a partially open cylinder (defining input and output).

The environmental temperature changes (at the input or output of the TIS, or inside the TIS) are created by using a heater or cooler, for example extending along the side walls and/or the upper wall of the gate.

A heater may for example be an electrical heater of any known type. The heater/cooler gate may be configured as an air screen or air conditioner. In order to facilitate an efficient heating/cooling of the sample, convection is enhanced by increasing the air velocity. Such techniques are known per se and therefore need not be described in more details.

When a body is transferred from a region outside the TIS (gate) into the TIS, which is for example achieved when bodies move along a certain path and pass through a gate (e.g., people walk through a gate; or envelopes/bags move on a conveyer through a gate), the temperature is appropriately regulated to apply an external temperature field onto the body, while in the gate, different from that outside the gate. Similarly, the environmental temperature changes can be applied to the body while located in the TIS, rather than being moved through the TIS. An appropriately oriented detection unit (i.e. radiation detector, such as IR detector, millimeter radiation range detector, or pyrometer) receives radiation coming from the body and being indicative of a response of the body (variations of radiation from the body) to the environmental temperature changes.

The gate arrangement preferably has an IR (or millimeter-range) reflective inner/outer surface. This provides for better separation of the two thermal zones (inside and outside the TIS), thereby enhancing the transient induction.

Preferably, the system also includes a reflector arrangement appropriately oriented with respect to the gate (e.g., sample path) to reflect the radiation coming from the body towards the detector location, thereby increasing the amount of detected response, particularly the angular span of the detector around the body.

As indicated above, generally, TIS can be formed naturally (without any specific gate arrangement), and a temperature detector is appropriately accommodated for collecting thermal data from a specific region to extract the concealed objects. A temperature difference on the order of 10 degrees Celsius is kept between at least two regions so that the transient response of the body (e.g., passenger and his garment) could be followed. As indicated above, the thermal data can be collected by any remote temperature sensor, such as IR camera, or millimeter wave detector, or pyrometer. Millimeter wave detection utilizes also the background of the body. However, a transient response separates better the human body from foreign objects by utilizing the thermal regulation of the body.

Applying data processing to the received radiation provides for mapping the thermal properties of the body from the time dependence of temperature during the transient response. This detection of physical properties allows for automatic detection of concealed objects having different thermal properties relative to the body carrying such an object; and also for eliminating the human background and therefore preserving the individual's privacy.

In addition, the system configuration may be such that the transient creates meta-stable states following the fast transient change. Thus, a meta-stable contrast is created repeatedly by a TIS gate even if the fast transient response is not recorded. In order to induce meta-stable states, a non-quasi-static process is employed by creating a tandem gate of alternating temperatures, by variation of the temperature in the gate or by any other means.

In yet another embodiment of the invention, the temperature field of a certain temperature gradient is applied to the body. This assists the detection process in cases the detector speed is too low to record the fast transient.

Thus, according to one broad aspect of the invention, there is provided a method of detecting a concealed foreign object carried by a body, the method comprising:
providing at least one transient inducing space (TIS) of environmental temperature changes to be entered by a body, the TIS being configured to enable concentration of a temperature field within the TIS and having a volume substantially large relative to that of the body;
subjecting the body to different temperature fields, when the body is located in the TIS or when the body enters the TIS from or emerges from the TIS to an outside region of a temperature field different from that of the TIS, thereby subjecting the body to environmental temperature changes; detecting a radiation from the body indicative of a response of the body to the environmental temperature changes; and generating thermal data indicative thereof;
processing the thermal data and producing output data indicative of a condition associated with the existence of a foreign object carried by the body.

Preferably, the TIS is a space inside a gate-like arrangement, which defines side walls (e.g., at opposite sides of the body path) and preferably also an upper wall (above the body path). The gate-like arrangement may have one of the following configurations: a substantially Π-shape gate, a substantially ∩-shape gate, and a carousel-like gate. Preferably, a surface of the gate arrangement is substantially reflective for the radiation coming from the body.

The subjecting of the body to the environmental temperature changes is achieved by heating or cooling the outside region at the input and/or output of the TIS, and/or heating or cooling the TIS. The heating/cooling is preferably achieved by blowing heated/cooled air into the TIS and/or the outside region. Another possible implementation is by selectively heating/cooling the person garment or the air trapped in his garment while complying with health regulations. This could be achieved for example by a selective micro-wave source.

The detecting of the radiation from the body includes collection of at least part of the radiation coming from the body by one pixel array detector or by array of such detectors. Preferably, the radiation, propagating from the body to various directions, is reflected towards the pixel array detector.

As indicated above, the gate-like arrangement may be provided by using a separate gate-like structure (e.g., accommodated in the body path); or by defining the body path through a gate-like structure defined by a certain existing construction.

The processing of the thermal data includes determining a time evaluation of the thermal data to detect the existence of at least two different time functions of the thermal data differing from each other by a certain character exceeding a certain threshold. This character is determined as: a difference between the functions; and/or rate of the function change; and/or a number of pixels of a radiation detector that detect different rates of the function change.

The output data may be indicative of at least one image of the body at least within a location corresponding to the character exceeding the threshold value. Generally, output data may be indicative of at least one image of the body.

The processing of the thermal data may include determining whether the detected radiation from the body is indicative of a body temperature change towards a temperature of the environment. This is indicative of the condition when the existence of a concealed object is undetectable.

The processing of the thermal data may utilize certain reference data. The reference data may be indicative of thermal data corresponding to various types of bodies, and/or thermal data corresponding to various types of objects, and/or thermal data corresponding to various conditions of environmental temperature changes affecting various types of bodies carrying various types of objects.

The processing of the thermal data may include determining a piece of the thermal data corresponding to a part of the body which is more likely to be uncovered by other materials, and using this thermal data piece as reference data. In the case of inspecting an individual for a concealed foreign object, this body part is the individual's face.

The invention may utilize image acquisition by a visual imaging system, concurrently with the detection of the thermal data. The acquired visual image(s) can be used to compensate for errors in the thermal data associated with a movement of the body, to identify a person at a later stage and/or to facilitate location of a foreign object carried by the body the existence of which has been detected from the thermal data.

The method and system of the invention may utilize the body path through an array of the TISs located in a spaced-apart relationship along the body path, where the temperature field inside each TIS is different from a temperature field outside said TIS. The temperature fields in the TISs may be substantially identical or different; as well as the temperature fields in the spaces between the TISs may be substantially identical or different.

Considering heating/cooling of the TIS, a constant temperature field within the TIS may be provided, or a certain temperature gradient of the temperature field within the TIS (e.g., along the body path through said TIS). The temperature field in the TIS may be dynamic (i.e. turbulent) enhancing the transient effect.

Preferably, a position sensor is used so as to actuate the detection of the radiation from the body upon determining a certain position of the body with respect to the TIS.

According to another broad aspect of the invention, there is provided a method of detecting a concealed foreign object carried by a body, the method comprising:
providing at least one gate-like arrangement having at least one of the following configurations: a substantially Π-shape gate, a substantially ∩-shape gate, and a carousel-like gate; a space inside the gate-like arrangement having a volume substantially large relative to that of the body and being a transient inducing space (TIS) of environmental temperature changes configured to allow concentrating a temperature field in the TIS;
subjecting the body to different temperature fields, when the body is located in the TIS or when the body enters the TIS from or emerges from the TIS to an outside region of a temperature field different from that of the TIS, thereby subjecting the body to environmental temperature changes; detecting a radiation from the body indicative of a response of the body to the environmental temperature changes; and generating thermal data indicative thereof;
processing the thermal data and producing output data indicative of a condition associated with the existence of a foreign object carried by the body.

According to yet another broad aspect of the invention, there is provided a method for use in detecting a concealed foreign object carried by a body, the method comprising:
collecting radiation from the body indicative of a response of the body to environmental temperature changes which the body is subjected when being located in a gate-like arrangement or when entering or emerging from the gate-like arrangement, the gate-like arrangement having at least one of the following configurations: a substantially Π-shape gate, a substantially ∩-shape gate, and a carousel-like gate, and having a volume substantially large relative to that of the body; and
generating thermal data indicative of the collected radiation.

According to yet another broad aspect of the invention, there is provided a system for use in detecting a concealed foreign object carried by a body, the system comprising:
at least one gate-like arrangement having one of the following configurations: side walls; and side walls and an upper wall; a space inside the gate-like arrangement being a transient inducing space (TIS) of environmental temperature changes and having a volume substantially large relative to that of the body, allowing applying to a body in the TIS a temperature field of a substantially uniform angular distribution within said TIS;
a temperature source appropriately accommodated with respect to the TIS and operable so as to provide a temperature field within the TIS different from a temperature field outside said TIS, thereby enabling subjecting the body to environmental temperature changes while entering the TIS from or emerging from the TIS to the outside region;
a detection unit configured and operable to receive radiation from the body and generate thermal data indicative of a response of the body to the environmental temperature changes;
a control unit configured to be responsive to the thermal data for processing the thermal data and producing output data indicative of a condition associated with the existence of a foreign object carried by the body.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic illustration of an example of a detection system of the present invention;

FIG. 2 is a schematic illustration of another example of a detection system of the present invention;

FIG. 3A is a schematic illustration of yet another example of a detection system of the present invention;

FIGS. 3B to 3E show experimental results obtained with the system of FIG. 3A to detect a concealed object carried by a person;

FIG. 4 schematically illustrates yet another implementation of a system of the present invention;

FIGS. 5A and 5B schematically illustrate yet another example of the present invention utilizing a carousel-like gate;

FIG. 6A to 6D exemplify how the present invention is used for detecting a gun in a coat pocket;

FIG. 7 shows how the present invention is used for detecting a dangerous object (knife) hidden in a bag;

FIGS. 8A and 8B show the experimental results of using the technique of the present invention for postal screening enabling detection of pills in an envelope;

FIGS. 9A-9B and 10A-10B show how the present invention allows for postal screening to detect white powder in an envelope.

### DETAILED DESCRIPTION OF THE INVENTION

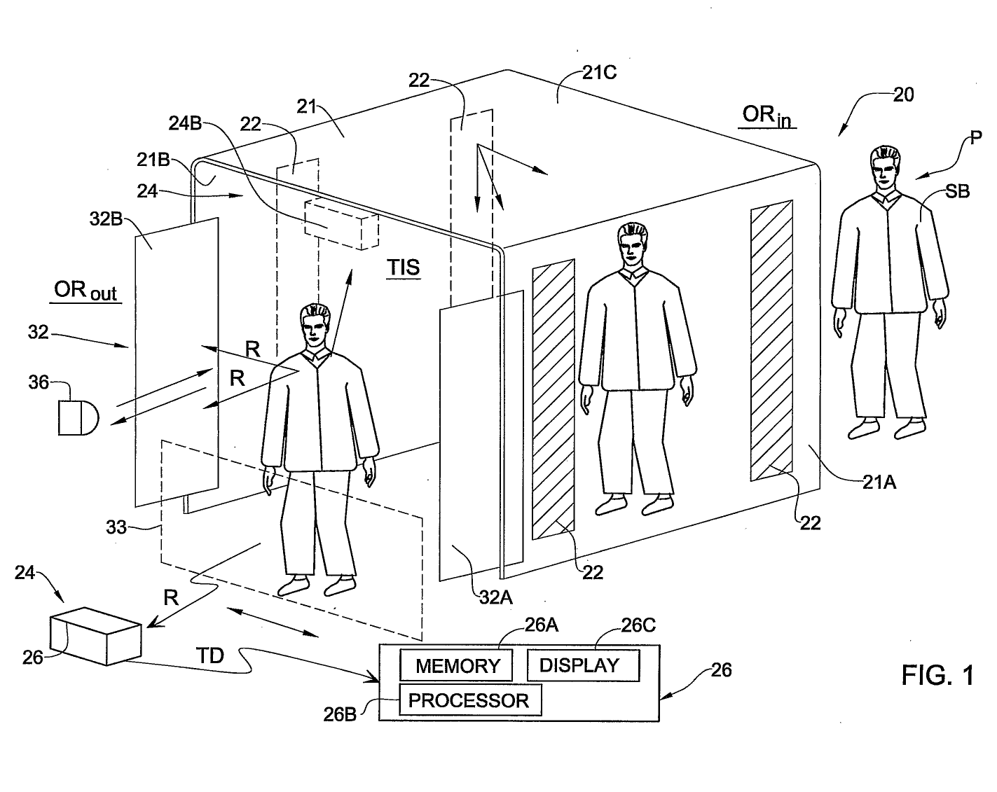

Referring to FIG. 1, there is schematically illustrated a detection system 20 of the present invention, which in the present example is shown as being used for detecting concealed objects that might be carried by a passenger P in a public place such as an airport for example. The system 20 includes one or more gate-like arrangement, a single gate 21 in the present example, located in the passenger path; a temperature source 22; a remote radiation detection unit 24; and a control unit 26.

In the present example, the gate 21 has a substantially Π-like shape having side walls 21A and 21B at opposite sides of the passenger path and an upper wall 21C. It should be noted, that the gate may be of ∩-like shape or carousel-like configuration. Generally, the gate may be formed only by side walls at opposite sides of the body path, or by side walls at opposite sides of the body path and an upper wall above the body path. A space inside the gate-like arrangement presents a transient inducing space TIS of environmental temperature changes, and has a volume substantially larger than that of the body. The TIS is maintained under a predetermined temperature field of a substantially uniform angular distribution within the TIS.

The temperature source 22 is appropriately accommodated with respect to the gate 21 (with respect to the TIS) and is operable so as to provide a temperature field inside the gate 21 different from a temperature field outside the gate, thereby enabling subjecting the passenger P to environmental temperature changes while entering the TIS from an outside region ORᵢₙ at the input to the TIS 21 or while emerging from the TIS to an outside region ORₒᵤₜ at the output of the TIS.

In the present example, the temperature source 22 is associated with the TIS 21, and includes one or more heaters or coolers—four such heaters or coolers being shown in the present example, or heater/cooler outlets accommodated at the side walls 21A and 21B of the gate 21 and operating for blowing heated (or cooled) air into the TIS. Also in the present example, the radiation from the passenger is detected at the output ORₒᵤₜ of the gate 21. It should be understood that the configuration can be such that the outside region ORᵢₙ at the input of the gate 21 is heated/cooled (e.g., by air conditioner) and passengers are “imaged” by collecting thermal radiation from inside the gate. Yet another possible configuration of subjecting a passenger substantially simultaneously and entirely to environmental temperature changes is by locating the temperature source at the gate and operating the source to sequentially apply different temperature fields to the TIS inside the gate. For example, the case may be such that a person while in the gate is invited to press two special buttons by his feet and two buttons by his hands. When this condition is satisfied, the detection is actuated, and if not satisfied the person is not allowed to output the gate.

The detection unit 24 includes one or more pixel array detector—two such detectors 24A and 24B being shown in the present example, configured and operable to receive radiation R from the passenger and generate thermal data TD indicative of a response of the passenger to the environmental temperature changes. This data is transmitted to the control unit 26 either via wires or wireless. The detector 24A (and 24B) is an IR or millimeter-range detector, or a pyrometer. Generally, the use of a matrix of thermocouples is possible in some applications.

The control unit 26 is typically an electronic system (computer system) configured to be responsive to the thermal data TD for processing this data and producing output data indicative of a condition associated with the existence of a foreign object carried by the passenger P. The control unit 26 includes inter alia a memory utility 26A, a data processing and analyzing utility 26B and a data output utility 26C (e.g., display). The control unit 26 is preprogrammed to carry out one of the following: processing the thermal data to produce output data indicative of an image of the passenger; processing the thermal data to produce an output signal indicative of the existence of a foreign object (including also a condition when such detection is impossible); and processing the thermal data to produce output data indicative of an image of the passenger only upon detecting the existence of a foreign object.

It should be understood that the term “data indicative of an image” refers to the actual image of a body, or a bit map of the thermal data from a body, or a bit map or actual image of a part of a body.

It should be understood that gate arrangement 21 defining the TIS may be formed by the building configuration (corridor) or a construction formed by walls of spaced-apart buildings. The heater/cooler (or heater/cooler outlets) may be mounted on the upper wall and/or on the side walls of the gate arrangement.

Preferably, the gate material is reflective to radiation coming from the body. Also preferably, the system 20 includes a reflector arrangement 32, which in the present example is formed by two reflectors 32A and 32B appropriately accommodated (e.g., mounted on the gate) and oriented so as to reflect the radiation R coming from the passenger towards the detector. Also preferably, a partition 33 is provided at the output of the gate. The partition 33 is of a normally closed or normally opened type and is driven (by a suitable drive assembly which is not specifically shown) between its opened and closed positions, being operated by the control unit based on the results of processing the thermal data. It should also be noted, although not specifically shown, that the system 20 preferably includes a position sensor appropriately accommodated with respect to the gate so as to detect a predetermined position of the passenger with respect to the gate, and actuate the thermal data collection while in the predetermined position of the passenger.

It should also be understood that the TIS may not be specifically heated/cooled, provided region ORᵢₙ outside this space from which passengers arrive to the gate and/or outside region ORₒᵤₜ entered by the passenger emerging from the gate, is heated/cooled. In other words, the heater/cooler is associated either with the gate arrangement or with input/output region of the gate arrangement, thereby providing that the TIS defined by the gate arrangement 21 is subjected to a temperature field different from that outside the gate. For example, considering that the gate arrangement (separate gate structure or a corridor region) is that associated with the proximity of an entry region of a building or building part from outdoors or from another building part, this entry region may be kept at a higher/lower temperature than that of the space defined by the gate arrangement. Thus, a passenger, while entering the gate arrangement from the entry region of the building or building part, becomes subjected to environmental temperature changes.

Heating/cooling the space defined by the gate arrangement by a stream of hot or cold air has the advantage of blowing on garment to press it against the concealed object, thereby increasing the contrast between the garment and concealed object in the thermal data indicative of the images of the garment and the concealed object. To inspect people entering for example a shopping mall, the entrance to the mall may be equipped with the gate arrangement 21 that directs heated or cooled air, depending on the season of the year, at people entering the mall.

The operation of the system 20 is based on the following: If the passenger carries a foreign object, e.g., a gun or explosive belt concealed by the passenger's garment, a combination of the passenger's body, garment and the foreign object is a generally solid body, and so the temperature T of this solid body obeys Fourier's law:

$$\frac{\partial T ( \vec{r} , t )}{\partial t} = κ ( \vec{r} ) {∇}^{2} T ( \vec{r} , t )$$

where \vec{r} is the spatial position within the solid body, t is time and κ(\vec{r}) is the thermal diffusivity of the solid body, wherein κ(\vec{r}) is a function of the material composition of this solid body.

The response of this solid body to a thermal perturbation is indicative of the material composition of the solid body. Initially (prior to being subjected to the environmental temperature changes), this solid body is in a steady state, with both the foreign object (e.g., explosive belt) and garment at a constant temperature. When the solid body enters the gate space and is thus entirely and simultaneously subjected to a different temperature field of a substantially uniform angular distribution, e.g., hot air elevating the temperature of at least a portion of the foreign object and/or garment above the initial temperature.

The detection unit 24 receives the thermal data indicative of a response of the solid body to the environmental temperature changes, for example captures infrared images of the body, while the body is substantially entirely and simultaneously heated by hot air and while the elevated temperature of the foreign object and garment decays to the steady state temperature, and generates thermal data indicative thereof. This thermal data (e.g., infrared images) may be displayed on the monitor 26C of the control unit 26. The thermal data is a map of T(\vec{r},t) at the surface of the solid body at the time t at which this data is collected (e.g., infrared image is acquired). The parameter κ(\vec{r}) of the solid body is inhomogeneous, and is sufficiently different within the foreign object as compared to that of the rest of the solid body, to thus render the thermal data (infrared images) to be indicative of the presence of the foreign object.

Solving the Fourier's law equation for κ(\vec{r}) gives:

$$κ ( \vec{r} ) = \frac{\partial T ( \vec{r} , t ) / \partial t}{{∇}^{2} T ( \vec{r} , t )}$$

Given two image-indicative data pieces (e.g., a pair of infrared images), the difference between these data is proportional to ∂T(\vec{r},t)/∂t. For each image-indicative data, a finite difference approximation to the Laplacian of the respective is obtained; the sum of the two approximate Laplacians is proportional to ∇²T(\vec{r},t). Dividing the difference between the two image-indicative data by the sum of the two approximate Laplacians provides a map of κ(\vec{r}) on the surface of the solid body. The maps of κ(\vec{r}) obtained from data indicative of successive pairs of images are further processed using any suitable known image processing technique to provide a final map of κ(\vec{r}), which can be displayed.

The infrared images can be acquired using a Jade MWIR (mid-wavelength infrared) camera made by CEDIP Infrared Systems of Croissy Beauborg, France, with a nominal NETD (noise-equivalent temperature difference) of 30 mK at 25° C. This wavelength band gives infrared images with good contrast because the slope of the black body radiation curve at typical ambient temperatures is strongly positive in this wavelength band. This wavelength band, however, requires cooling of the sensor array of a thermal camera. Alternatively, the thermal camera (detector) may be sensitive in the eight to twelve micron wavelength band. The resulting images have less contrast because this band is near the peak of the black body radiation curve at typical ambient temperatures, but sensor arrays for this wavelength band do not require cooling. For example, a focal plane array of bolometric elements can be used.

It is relatively straightforward for an operator of the system 20 to detect a concealed object (e.g., an explosive belt carried beneath a shirt) by inspection of the infrared images displayed on monitor 26C. To detect a more skillfully concealed explosive belt, for example an explosive belt concealed beneath an overcoat, the infrared images are stored in a memory 26A of the control unit 26 and processed by the processor 26B.

It should be noted that certain reference data may be provided and stored in the memory, being indicative of thermal of various types of bodies; and/or thermal data of various types of objects; and/or thermal data corresponding to various conditions of environmental temperature changes affecting various types of bodies carrying various types of objects.

The data processing utility 26B typically is a digital processor, and the infrared images are processed digitally. Alternatively, the processor 26B may be an optical processor or an analog processor, and the infrared images are processed optically or by analog means.

The processor 26B is preprogrammed for analyzing the thermal data TD to determine a time evaluation of the thermal data to detect the existence of at least two different time functions of the thermal data which differ from each other by a certain character exceeding a certain threshold. Such a character may be determined as a difference between the time functions; and/or as a rate of the function change; and/or the function behavior at the asymptotic region; and/or as a number of pixels of the radiation detector 24A (and/or 24B) that detect different values of the function change rate.

The condition associated with the existence of the foreign object to be detected may be a condition of the detected existence of a foreign object (and possible also of the location of such object on the passenger); a condition of absence of any foreign object; or a condition that the detection is impossible, for example because of a too thick garment worn by the passenger. The processor may for example be preprogrammed to determine whether the detected radiation from the body is indicative of a body temperature change towards a temperature of the environment. This is indicative of the condition when the existence of a concealed object is undetectable. The processor may operate to utilize a piece of the thermal data associated with the passenger's face (generally a region of the body which is more likely to be uncovered by other materials) as a reference data to separate between the body-associated response and that of a foreign object.

Preferably, the system 20 also includes a visual imaging system (camera) 36 which operates to acquire visual images of the passenger, substantially simultaneously with the capture of the thermal data (e.g., infrared images) of the passenger by the thermal detection unit 24. Camera 36 serves as a reference camera. The use of visual image(s) for processing the thermal data allows to compensate for movement of the passenger, as well as to facilitate locating of the object on the passenger. The visible images are stored along with the thermal data in the memory utility 26A of the control unit 26. Any suitable known image processing technique can be used to identify and track the solid body in the visible images. The control unit 26 operates to transfer the location of the solid body in each visible image to the corresponding thermal data (infrared image), and registers the thermal data with each other to compensate for the movement of the solid body in the calculation of the map of κ(\vec{r}).

To facilitate the transfer of the location of the solid body from the visible images to the infrared images, it is preferable that cameras 24 and 36 have a common field of view. This can be implemented by utilizing a wavelength-selective element (dichroic mirror) which is substantially transparent to one of the infrared and visible ranges and reflective to the other, for example a germanium plate which is transparent for infrared wavelength range and reflective for visible range. The cameras 24 and 36 are appropriately oriented with respect to the wavelength-selective element, such that the visible and infrared radiation paths are combined by the wavelength-selective element.

The following are some examples of a system of the present invention. To facilitate understanding, the same reference numbers are used for identifying those components that are common in all the examples of the invention.

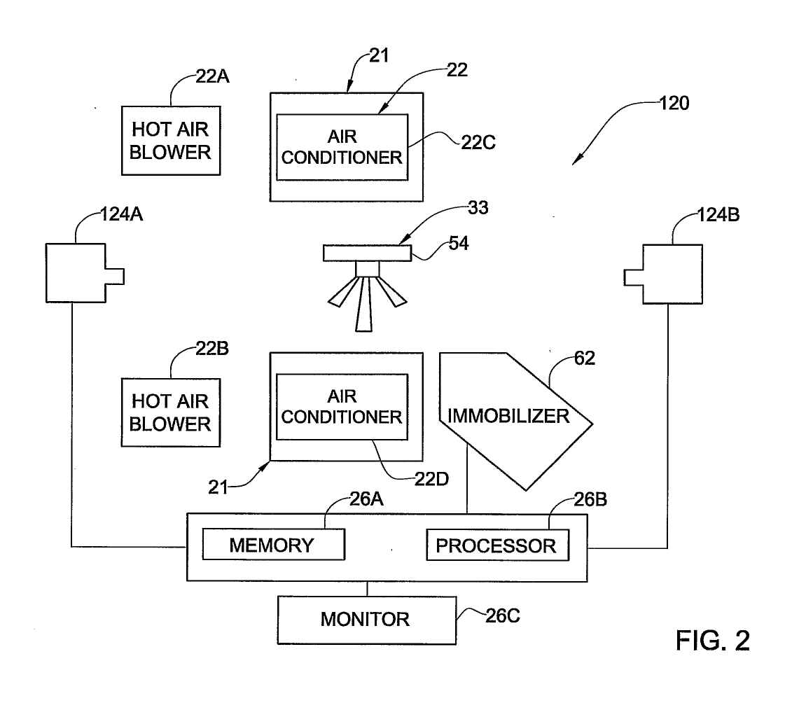

Reference is made to FIG. 2 schematically illustrating a system 120 that includes a gate arrangement 21; a temperature source 22; a detection unit 24; and a control unit 26. The gate arrangement 21 may for example be formed by a part of a corridor, such as typically used as passengers' path to an aircraft. It should be understood that the gate 21 (including side walls and preferably also an upper wall) may be made of any suitable materials, including also fabrics. The temperature source 22 includes two hot air blowers or air conditioners (or air conditioner outlets) 22A and 22B on opposite sides of the passengers' path at the entrance of corridor upstream of the gate 21, and two air conditioning units 22C and 22D blowing cold air to the space in the gate (corridor). A turnstile 33 delays the entrance of a person to the facility downstream of the gate long enough for the detection unit 24 to collect data indicative of image(s) of the person. The detection unit 24 includes two cameras 124A and 124B configured to collect radiation from two different points of view. Cameras 124A and 124A are thermal cameras or preferably multispectral cameras, sensitive in both an “ambient” infrared band (such as the three to five micron band or the eight to twelve micron band), in which ambient temperature contrasts can be imaged, and in a reference wavelength band (such as a visible band or a near infrared band), that is relatively insensitive to ambient temperature contrasts. Cameras 124A and 124B capture infrared images of the person at turnstile 33 in the ambient infrared band and reference images of the person at turnstile 33 in the reference wavelength band. Preferably, the reference wavelength band is a near infrared band because it is easier to make a sensor array that is sensitive in two infrared bands than to make a sensor array that is sensitive in both an ambient infrared band and a visible band. Thermal data (indicative of infrared images) and reference images are transmitted from cameras 124A and 124B to the control unit 26. Cameras 124A and 124B are preferably in stand-off positions relative to turnstile 33 so that if would-be suicide bomber chooses to detonate explosive belt at turnstile 33 cameras 124A and 124B are not damaged.

If the control unit 26 identifies a dangerous concealed object such as explosive belt in the images received from cameras 124A and 124B, or if an operator of system 120 identifies such a dangerous concealed object in the images displayed on monitor 26C, sticky foam is dispensed from a dispenser 62 to immobilize the person at turnstile 33. As indicated above, the control unit might generate output indicative of the impossibility of detection of the existence of any dangerous object. The configuration may be such that turnstile 33 directs people identified as dangerous or unidentifiable in one exit direction and people identified as not dangerous in another exit direction.

It should be noted that as thermal cameras are now available that have a nominal NETD of 10 mK at ambient temperatures, these thermal cameras are sufficiently sensitive that ambient temperature fluctuations of the environment of a body, for example due to breezes, are sufficient to produce enough contrast in the acquired infrared images of the body to allow a computation of κ(\vec{r}) as described above. A system of the present invention that uses such thermal camera(s) eliminates a need for a specific temperature source for transiently heating or cooling the body.

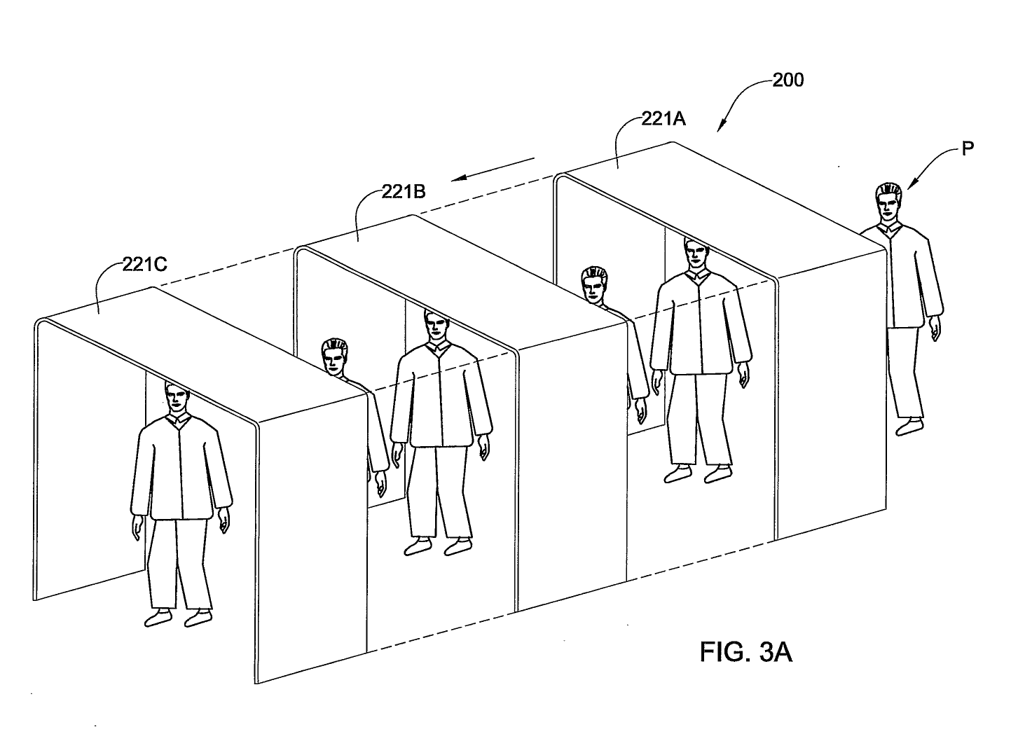

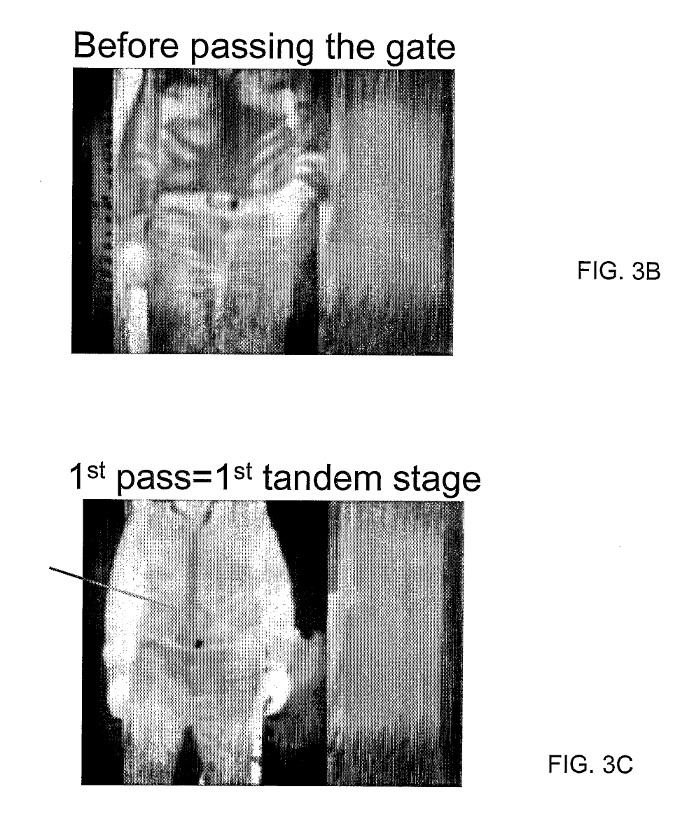

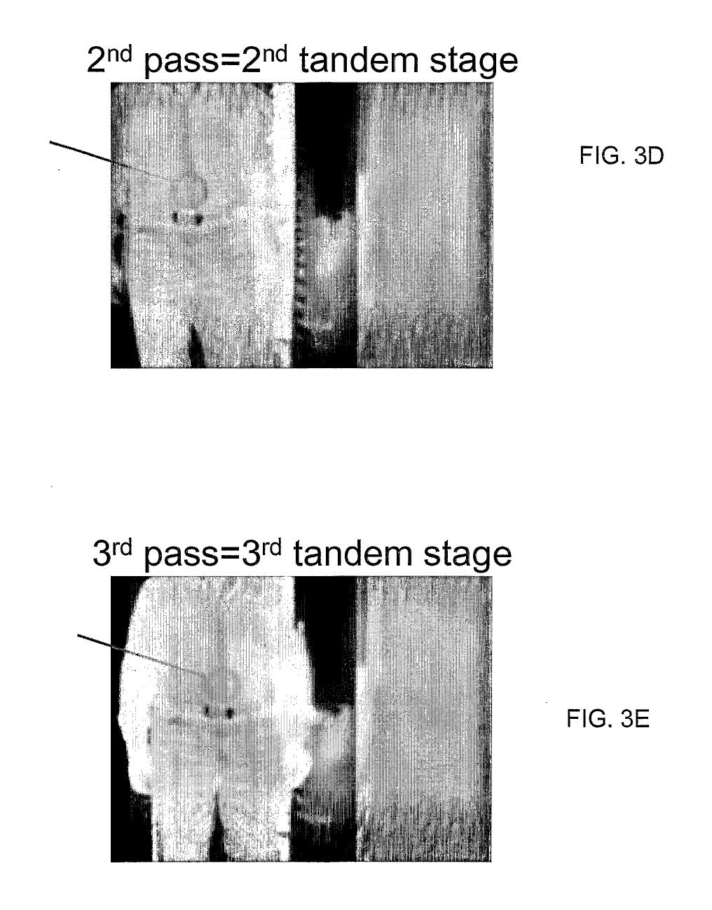

Reference is now made to FIG. 3A illustrating a system 200 according to another example of the invention for detecting the existence of a foreign concealed object carried by a passenger. The system 200, is different from the above-described system 20 (as well as system 120) in that a gate arrangement 221 is configured so as to define several (generally at least two) successive spaced-apart regions each presenting a TIS, spaced from each other by regions having a temperature or temperatures different from that or those of the TIS regions. A temperature source is appropriately provided (including heater/coolers in the TISs and/or in the spaces between the TISs), which is not specifically shown, to ensure that a temperature within each TIS region (inside each gate region) is different from that of the respective space region at the entry to this gate region, considering a certain direction of passengers' path. It should be understood that the gates and the spaces between them may actually be formed by a common corridor-like region, where for example the gates are made from a different material (reflective to the radiation that is to be detected) than that of the spaces between them. In the present example, three such gate regions 221A-221C are used. Each such TIS region presents a tandem stage in multi-stage transient initiation process. A passenger P while traveling along a path sequentially passes through the TIS regions 221A-221C, and while being successively subjected to environmental changes when entering the TIS region and emerging therefrom, thermal data is collected by radiation detector(s), which is/are not specifically shown here.

FIGS. 3B-3E show output data (image indicative data) produced by the control unit (not shown) as a result of processing the collected thermal data. FIG. 3B shows the image of the passenger before passing the first gate 221A. FIG. 3C-3E show the passengers' images at, respectively, 1^{st}-3^{rd} tandem stages after passing three gate regions 221A-221C. As shown, the first image, taken before subjecting the passenger to the environmental temperature changes, has no data indicative of any concealed object, while each of three images taken after subjecting the passenger to the environmental temperature changes shows a ring-like concealed object at the same location on the passenger. Moreover, the image contrast is enhanced from stage to stage.

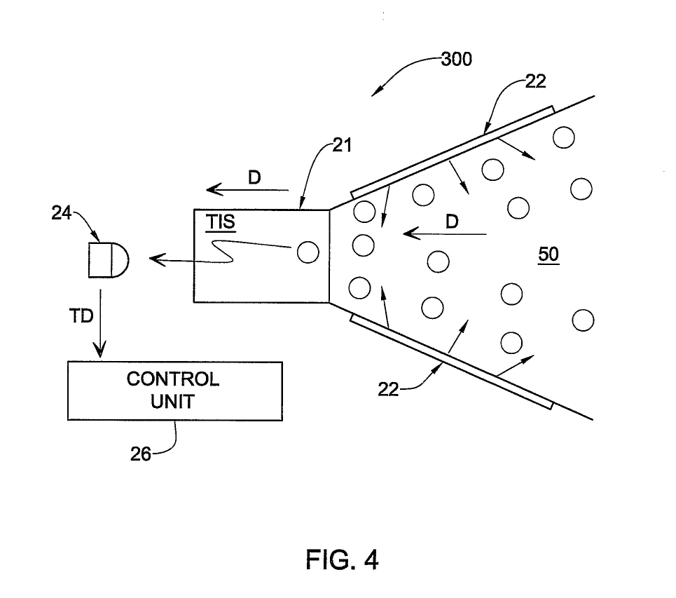

Reference is made to FIG. 4 showing yet another example of a system 300 of the invention. The system 300 is formed by a gate-like arrangement 21, a temperature source 22, a detection unit 24, and a control unit 26. The gate 21 is a TIS formed by a relatively narrow corridor at the output of a relatively wide corridor region 50. In the present example, the temperature source 22 is associated with the corroder region 50, while the gate region 21 may or may not include any temperature source. The region 50 is heated (e.g., by air conditioner installed in that region). The gate space may for example be specifically cooled. People passing through a building in a direction D are caused to pass through the gate one by one because of the gate-corridor configuration, and can thus be “imaged” by the detection unit while being subjected to the environmental changes when entering the gate 21.

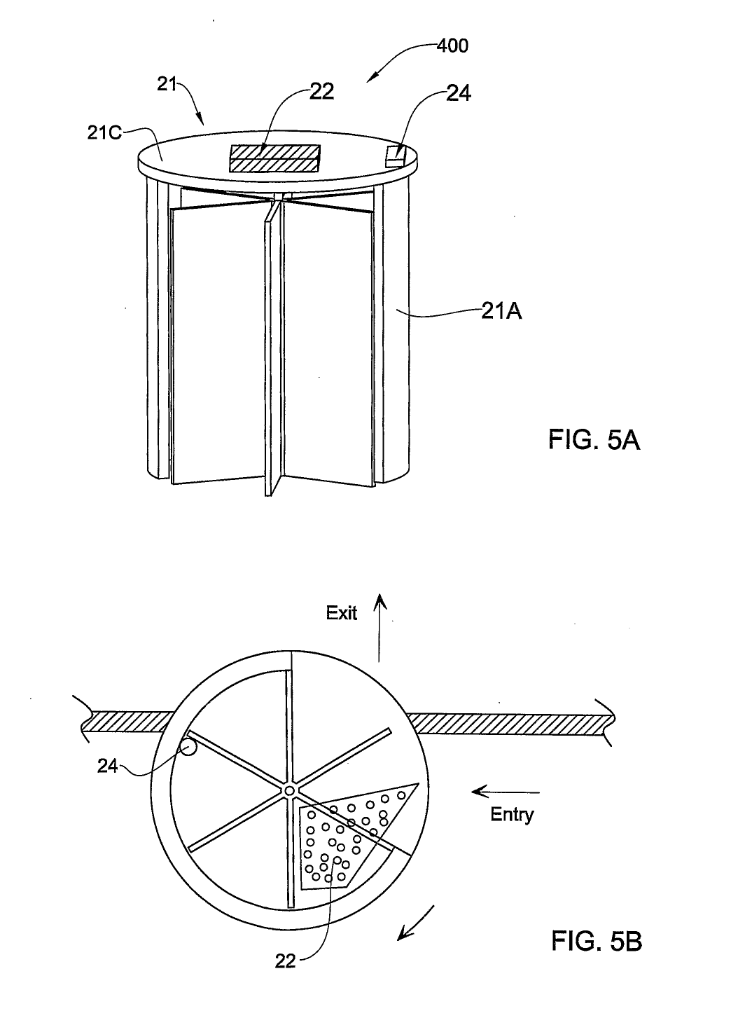

Reference is made to FIGS. 5A and 5B showing yet another example of a system 400 according to the invention. In the system 400, a gate-like arrangement 21 is in the form of a carousel-like gate. A temperature source 22 is formed by a heater/cooler located above the upper wall of the carousel which is appropriately provided for air flow openings. The carousel is configured such that the compartment walls, during the carousel rotation, are brushing an upper wall 21C and an outer partially opened cylinder 21A (constituting side walls). A detection unit 24 is appropriately accommodated to image a person while being subjected to environmental temperature changes, namely either when entering a heated/cooled compartment of the carousel, or when emerging therefrom to a successive compartment. In the present example, the detection unit 24 includes a single camera mounted at the upper wall 21C. The configuration can be such that the carousel rotates (causing the person to pass through the heated/cooled location) not allowing a person to emerge therefrom until the person is imaged from both sides; and/or the configuration may be such that people identified as dangerous (or those who cannot be identified by the system, e.g., because of too thick garment) are directed in one exit direction and people identified as not dangerous in another exit direction.

The following are some experimental results of the technique of the present invention.

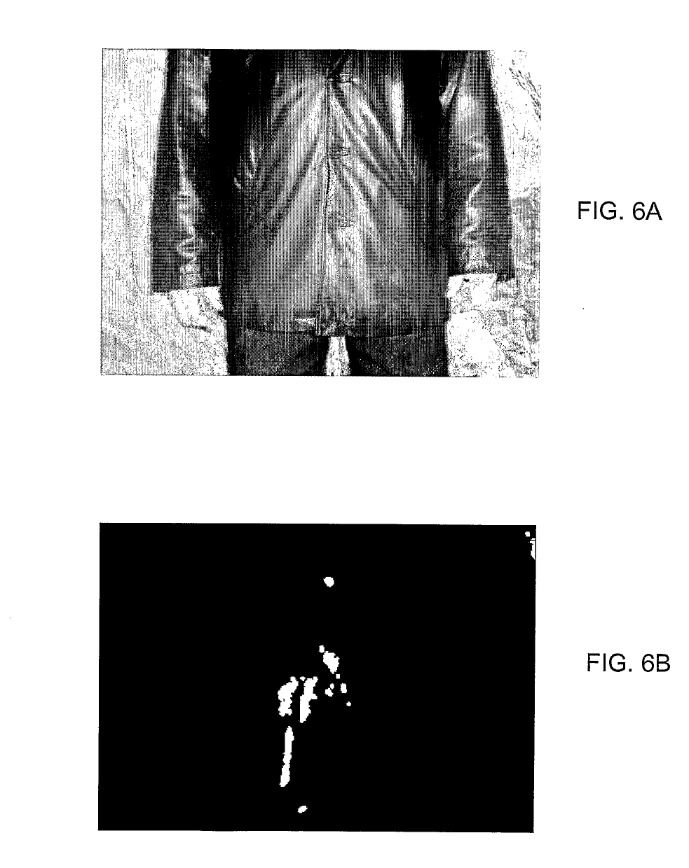

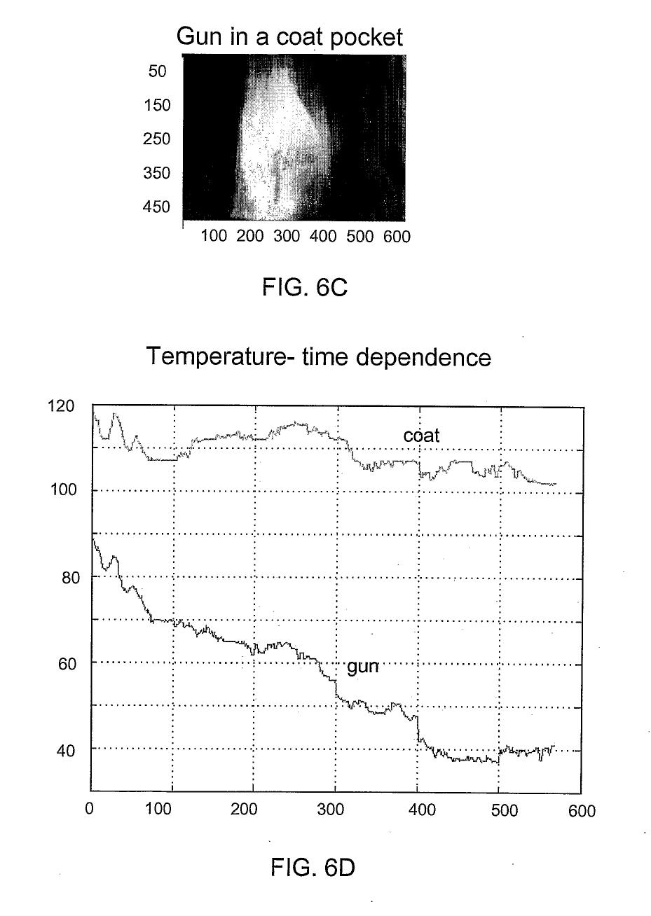

FIGS. 6A-6D illustrate how the present invention is used for detecting a gun in a coat pocket. FIGS. 6A and 6B show, respectively, a person wearing a coat with pockets, and data indicative of infrared image of a gun in the pocket. This data is obtained by processing thermal data detected while subjecting the person to environmental temperature changes using the person pass through the gate-like arrangement similar to that of FIG. 1. FIG. 6C shows the detected thermal data indicative of an image of the person with a foreign object in his pocket. FIG. 6D shows the processing of this thermal data. Two graphs are shown presenting the time functions of temperature changes of different materials on the person's body: one graph presents the coat-related function and the other the gun-related function. By determining a rate of change for these functions, the gun-image is automatically created as a bright pattern on a dark background (FIG. 6B).

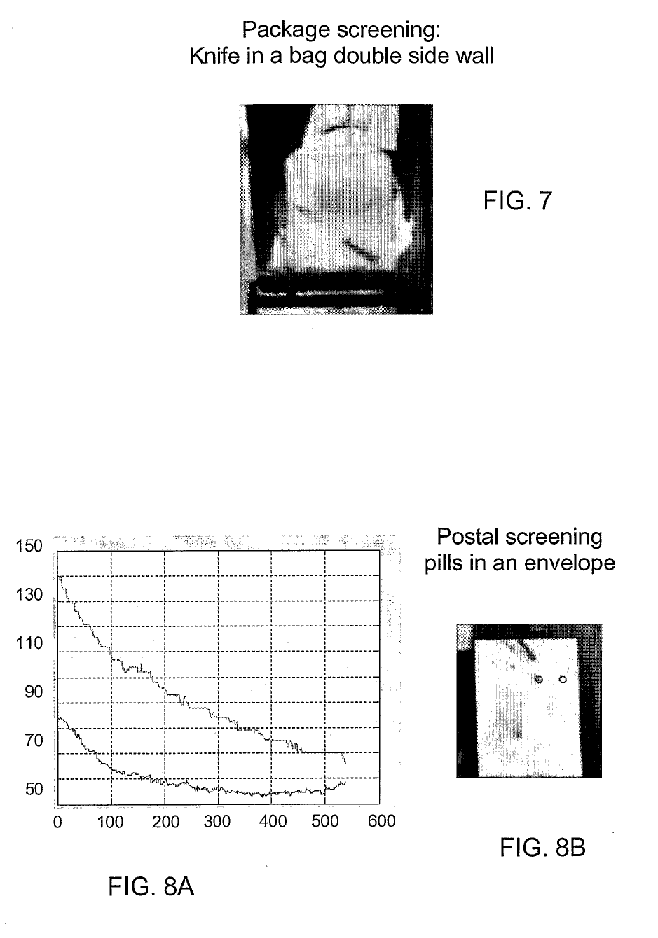

FIG. 7 illustrates how the technique of the present invention enables detection of a knife in a bag with double side walls. Such image-data can be obtained while moving bags on a conveyer passing through a gate or while manually inserting a bag into the gate TIS.

FIGS. 8A and 8B show the experimental results of using the technique of the present invention for postal screening enabling detection of pills in an envelope. FIG. 8A shows the time evaluation of temperatures of different materials within the envelope. A difference between these time functions is above a threshold value and accordingly an image is created (FIG. 8B) showing pills in the envelope. Such inspection of envelopes is for example carried out while envelopes move on a conveyer to pass through a gate and be subjected to environmental temperature changes when entering the gate and/or when emerging therefrom.

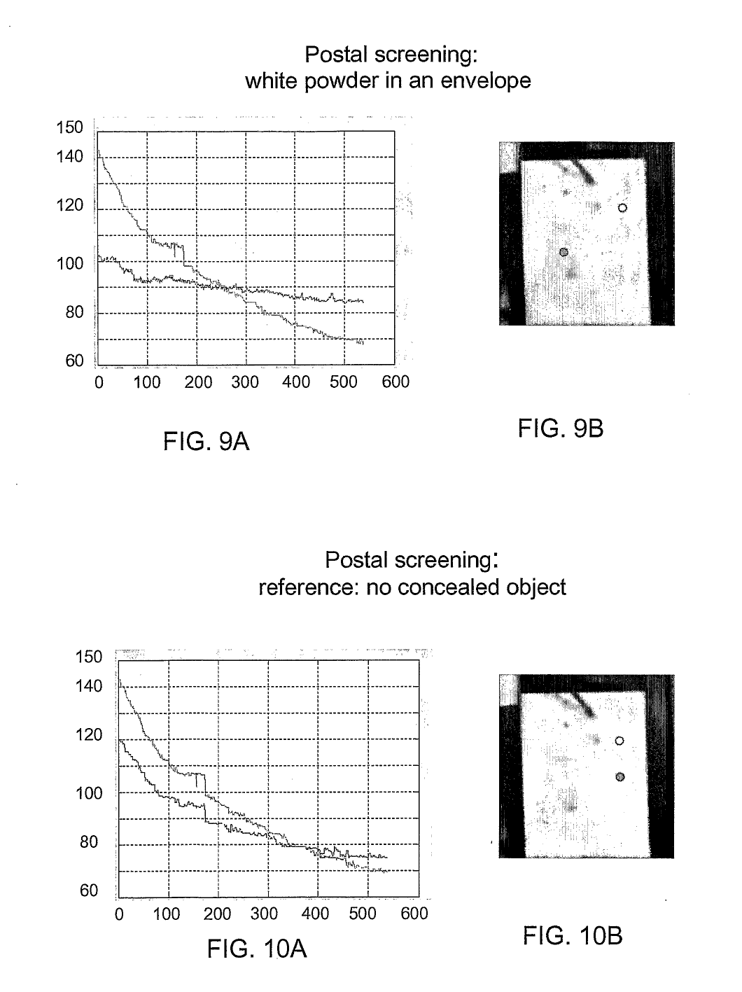

FIG. 9A-9B and 10A-10B show the results of an envelope screening process. FIGS. 9A and 9B illustrate an envelope region where white powder has been detected. Time variations of temperatures of different materials within this envelope region, shown in FIG. 9A, are different from each other by a value above a threshold value. An infrared image (FIG. 9B) shows the white powder in the envelope. FIGS. 10A and 10B illustrate a region of the envelope free of any concealed object. Here, the detected time variations of the envelope temperature (FIG. 10A) are below a threshold value.

Thus, the present invention provides an efficient detection of the existence of a concealed object carried by a body. The invention utilize simple and non-expensive means and allows for using heating/cooling means as well as constructions existing in such public places where the people inspection for concealed objects is required; provides for successful detection while applying environmental temperature changes of about 10° C. or even less to the body.

Those skilled in the art will readily appreciate that various modifications and changes can be applied to the embodiments of the invention as hereinbefore described without departing from its scope defined in and by the appended claims.

1. A method of detecting a concealed foreign object carried by a body, the method comprising:
providing at least one transient inducing space (TIS) of environmental temperature changes to be entered by a body, the TIS being configured to enable concentration of a temperature field within the TIS and having a volume substantially large relative to that of the body;
subjecting the body to different temperature fields, when the body is located in the TIS or when the body enters the TIS from or emerges from the TIS to an outside region of a temperature field different from that of the TIS, thereby subjecting the body to environmental temperature changes; detecting a radiation from the body indicative of a response of the body to the environmental temperature changes; and generating thermal data indicative thereof;
processing the thermal data and producing output data indicative of a condition associated with the existence of a foreign object carried by the body.

2. The method of claim 1, wherein the TIS is a space inside a gate-like arrangement.

3. The method of claim 2, wherein the gate-like arrangement has one of the following configurations: side walls at opposite sides of the body path; and side walls at opposite sides of the body path and an upper wall above the body path.

4. The method of claim 3, wherein said at least one gate-like arrangement has one of the following configurations: a substantially Π-shape gate, a substantially ∩-shape gate, and a carousel-like gate.

5. The method of claim 1, wherein said radiation coming from the body is infrared or millimeter-range radiation.

6. The method of claim 1, wherein said environmental temperature changes substantially do not exceed 10° C.

7. The method of claim 1, wherein the subjecting of the body while in the TIS to the temperature field comprises carrying out at least one of the following: heating or cooling the outside region at the input and/or output of the TIS, and heating or cooling said TIS.

8. The method of claim 7, comprising blowing a heated or cooled air into at least one of the TIS and the outside region.

9. The method of claim 1, wherein said detecting of the radiation from the body comprises collecting at least part of the radiation coming from the body by at least one pixel array detector.

10. The method of claim 1, wherein said detecting of the radiation from the body comprises reflecting the radiation, propagating from the body to various directions, towards said at least one pixel array detector.

11. The method of claim 2, wherein a surface of the gate arrangement is substantially reflective for the radiation coming from the body.

12. The method of claim 2, wherein said at least one gate-like arrangement is provided by accommodating in the body path a separate gate-like structure.

13. The method of claim 2, wherein said at least one gate-like arrangement in the body path is provided by defining the body path through a gate-like structure defined by a certain existing construction.

14. The method of claim 1, wherein said processing of the thermal data comprises determining a time evaluation of the thermal data to detect the existence of at least two different time functions of the thermal data differing from each other by a certain character exceeding a certain threshold.

15. The method of claim 14, wherein said character is indicative of at least one of the following: a difference between the functions, a rate of the function change, the function behavior at an asymptotic region, and a number of pixels of a radiation detector that detect different rates of the function change.

16. The method according to claim 1, wherein said output data is indicative of at least one image of at least a part of the body.

17. The method of claim 1, wherein said output data is indicative of a condition when the existence of a concealed object is undetectable.

18. The method of claim 17, wherein said processing of the thermal data comprises determining whether the detected radiation from the body is indicative of a body temperature change towards a temperature of the environment.

19. The method of claim 1, wherein said processing, of the thermal data comprises utilizing certain reference data indicative of at least one of the following: thermal data corresponding to various types of bodies, thermal data corresponding to various types of objects, and thermal data corresponding to various conditions of environmental temperature changes affecting various types of bodies carrying various types of objects.

20. The method of claim 1, wherein said processing of the thermal data comprises determining a piece of the thermal data corresponding to a part of the body which is more likely to be uncovered by other materials, and using this thermal data piece as reference data.

21. The method of claim 20, wherein the body is an individual, the body part is the individual's face.

22. The method of claim 1, comprising concurrently with the detection of the thermal data, acquiring at least one image of the body using an optical system.

23. The method of claim 22, wherein said processing of the thermal data comprises utilizing the at least one acquired image to compensate for errors in the thermal data associated with a movement of the body.

24. The method of claim 22, wherein said processing of the thermal data comprises utilizing the at least one acquired image to facilitate location of a foreign object carried by the body.

25. The method of claim 1, wherein said subjecting of the body to the environmental temperature changes comprises defining a body path through an array of the TISs located in a spaced-apart relationship along the body path, where the temperature field inside each TIS is different from a temperature field outside said TIS.

26. The method of claim 25, comprising carrying out at least one of the following: providing the substantially identical or different temperature fields inside the TISs; and providing the substantially identical or different temperature fields within the spaces between the TISs.

27. The method of claim 1, comprising providing the static temperature field within the TIS.

28. The method of claim 1, comprising providing a certain temperature gradient of the temperature field within the TIS along a body path through said TIS.

29. The method of claim 1, comprising actuating the detection of the radiation from the body upon determining a certain position of the body with respect to the TIS.

30. A method of detecting a concealed foreign object carried by a body, the method comprising:
providing at least one gate-like arrangement having at least one of the following configurations: a substantially Π-shape gate, a substantially ∩-shape gate, and a carousel-like gate; a space inside the gate-like arrangement having a volume substantially large relative to that of the body and being a transient inducing space (TIS) of environmental temperature changes configured to allow concentrating a temperature field in the TIS;
subjecting the body to different temperature fields, when the body is located in the TIS or when the body enters the TIS from or emerges from the TIS to an outside region of a temperature field different from that of the TIS, thereby subjecting the body to environmental temperature changes; detecting a radiation from the body indicative of a response of the body to the environmental temperature changes; and generating thermal data indicative thereof;
processing the thermal data and producing output data indicative of a condition associated with the existence of a foreign object carried by the body.

31. A method for use in detecting a concealed foreign object carried by a body, the method comprising:
collecting radiation from the body indicative of a response of the body to environmental temperature changes which the body is subjected when being located in a gate-like arrangement or when entering or emerging from the gate-like arrangement, the gate-like arrangement having at least one of the following configurations: a substantially Π-shape gate, a substantially ∩-shape gate, and a carousel-like gate, and having a volume substantially large relative to that of the body; and
generating thermal data indicative of the collected radiation.

32. A system for use in detecting a concealed foreign object carried by a body, the system comprising:
at least one gate-like arrangement having one of the following configurations: side walls; and side walls and an upper wall; a space inside the gate-like arrangement being a transient inducing space (TIS) of environmental temperature changes and having a volume substantially large relative to that of the body, allowing applying to a body in the TIS a temperature field of a substantially uniform angular distribution within said TIS;
a temperature source appropriately accommodated with respect to the TIS and operable so as to provide a temperature field within the TIS different from a temperature field outside said TIS, thereby enabling subjecting the body to environmental temperature changes while entering the TIS from or emerging from the TIS to the outside region;
a detection unit configured and operable to receive radiation from the body and generate thermal data indicative of a response of the body to the environmental temperature changes;
a control unit configured to be responsive to the thermal data for processing the thermal data and producing output data indicative of a condition associated with the existence of a foreign object carried by the body.

33. The system of claim 32, wherein the gate-like arrangement has one of the following configurations: a substantially Π-shape gate, a substantially ∩-shape gate, and a carousel-like gate.

34. The system of claim 32, wherein said detection unit is configured for receiving infrared or millimeter-range radiation and generate the thermal data.

35. The system of claim 32, wherein said temperature source is configured and operable to create the environmental temperature changes substantially not exceeding 10° C.

36. The system of claim 32, wherein said temperature source comprises one or more heater or cooler accommodated to heat or cool the outside of the TIS and/or the TIS.

37. The system of claim 36, wherein the temperature source comprises at least one blower of a heated or cooled air.

38. The system of claim 36, wherein the heater or cooler is associated with at least one of the following: the side walls of the gate-like arrangement, and the upper wall of the gate-like arrangement.

39. The system of claim 32, wherein said detection unit comprises at least one pixel array detector.

40. The system of claim 32, wherein said detection unit comprises at least two pixel array detectors accommodated to collect the radiation propagating from the body in different directions, respectively.

41. The system of claim 32, comprising a radiation reflecting arrangement accommodated in or adjacent to the gate-like arrangement so as to reflect the radiation coming from the body towards the detection unit.

42. The system of claim 32, wherein a surface of the gate is substantially reflective for the radiation coming from the body.

43. The system of claim 32, wherein said processing of the thermal data comprises determining a time evaluation of the thermal data to detect the existence of at least two different time functions of the thermal data differing from each other by a certain character exceeding a certain threshold.

44. The system of claim 43, wherein said character is indicative of at least one of the following: a difference between the functions, a rate of the function change, the function behavior at an asymptotic region, and a number of pixels of the detector unit that detect different rates of the function change.

45. The system of claim 32, wherein said output data is indicative of at least one image of at least a part of the body.

46. The system of claim 32, wherein said output data is indicative of the condition when the existence of a concealed object is undetectable.

47. The system of claim 46, wherein said processing of the thermal data comprises determining whether the detected radiation from the body is indicative of a body temperature change towards a temperature of the environment.

48. The system of claim 32, wherein said control unit comprises a memory utility for storing certain reference data indicative of at least one of the following: thermal data corresponding to various types of bodies, thermal data corresponding to various types of objects, and thermal data corresponding to various conditions of environmental temperature changes affecting various types of bodies carrying various types of objects.

49. The system of claim 32, wherein said processing of the thermal data comprises determining a piece of the thermal data corresponding to a part of the body which is more likely to be uncovered by other materials, and using this thermal data piece as reference data.

50. The system of claim 32, comprising an optical imaging system configured and operable for acquiring at least one image of the body.

51. The system of claim 50, wherein said processing of the thermal data comprises utilizing the at least one acquired image to compensate for errors in the thermal data associated with a movement of the body.

52. The system of claim 50, wherein said processing of the thermal data comprises utilizing the at least one acquired image to facilitate location of a foreign object carried by the body.

53. The system of claim 32, comprising an array of the TISs located in a spaced-apart relationship along the body path, the temperature field inside each TIS being different from a temperature field outside the TIS.

54. The system of claim 32, wherein the temperature source is configured and operable to provide a certain temperature gradient of the temperature field within the TIS along the body path through said TIS.

55. The system of claim 32, comprising a position sensor accommodated to detect a certain position of the body with respect to the TIS to thereby actuate the detection of the radiation from the body.
